(19) United States
(12) Patent Application Publication
(10) Pub. No.: US 2009/0064284 A1
(43) Pub. Date: Mar. 5, 2009

(54) Method and System for Access to Material on a Web Site

(75) Inventors: Timothy Poston, Bangalore (IN); Tomer Shalit, Holmsund (SE); Mark Dixon, Skarholmen (SE)

Correspondence Address: ALBIHNS STOCKHOLM AB, BOX 5581, LINNEGATAN 2, SE-114 85 STOCKHOLM; SWEDENn, STOCKHOLM, SE

(73) Assignee: PADO METAWARE AB, Umea (SE)

(21) Appl. No.: 12/037,127

(22) Filed: Feb. 26, 2008

Related U.S. Application Data
(60) Provisional application No. 60/891,537, filed on Feb. 26, 2007.

(51) Int. Cl. H04L 9/30; G06F 21/20

(52) U.S. Cl. 726/4

(57) ABSTRACT

A user connected to a first service mounted on a remote server is enabled to connect to a second service, on the same or another server, without new steps required for log-in, and optionally including the passing of parameters from the first to the second service that enable the second service to open in a manner appropriate to the state of the user's interaction with the first service at the moment of requesting the connection. In the case of the second service being provided from a second server, authentication is provided by means of an authentication broker, which provides a token that the operating system of the user's computer is induced (via its normal response to received messages) to embed in a request for service to the second server, which verifies the token by an exchange with the broker. In either case, once the connection with the second server is achieved, later repeated access may be enabled without the user having to go through the procedure required to enable such access from scratch.

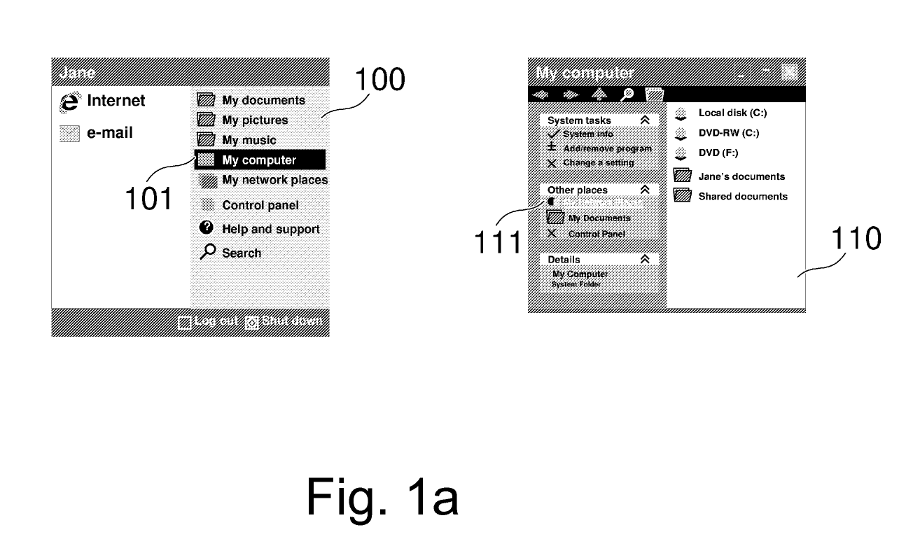

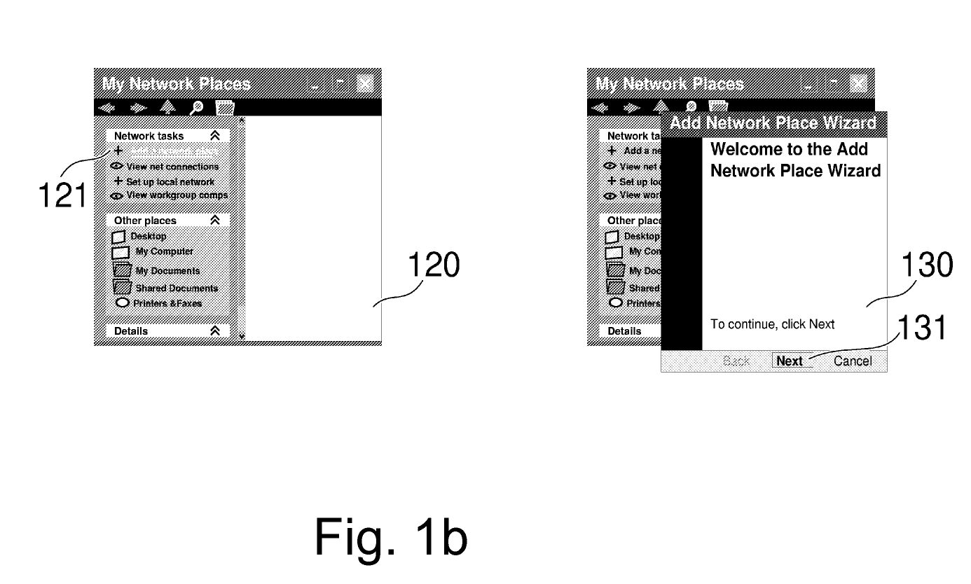

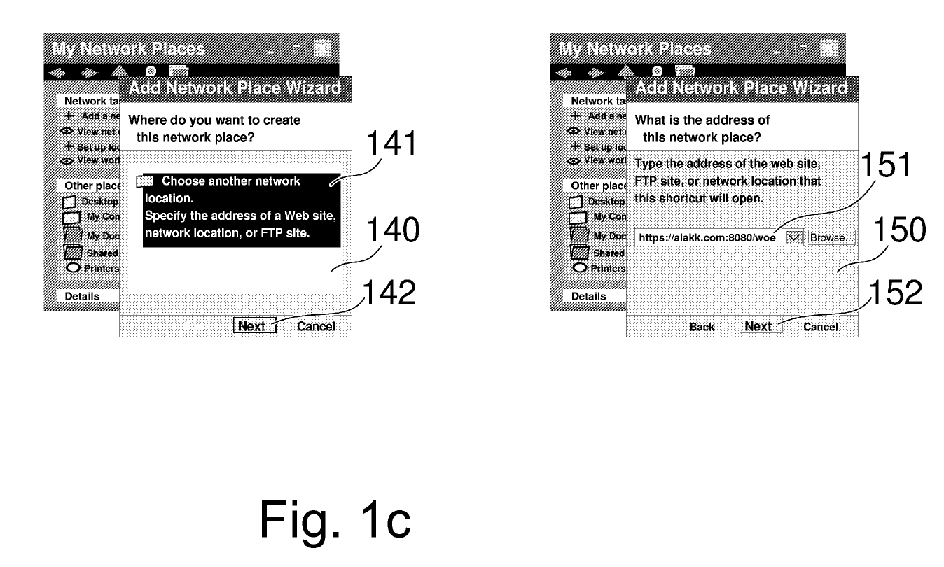

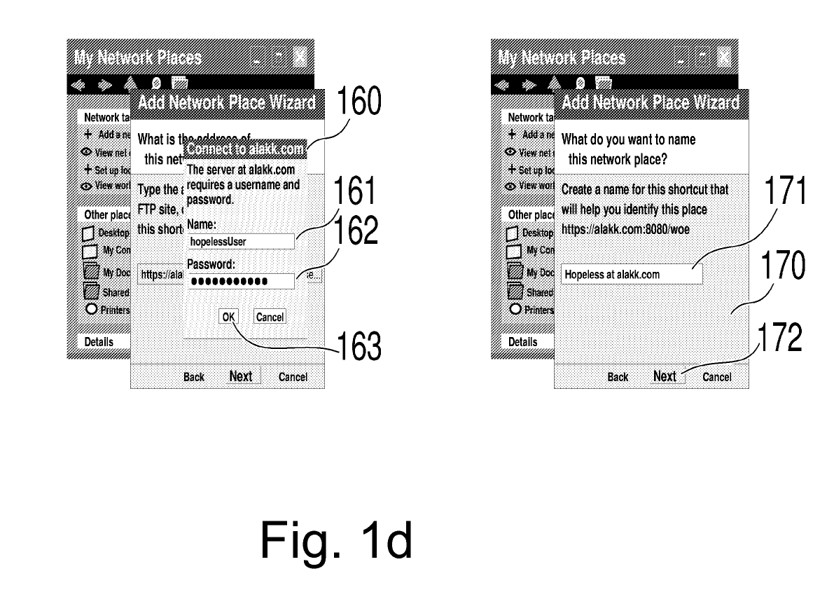

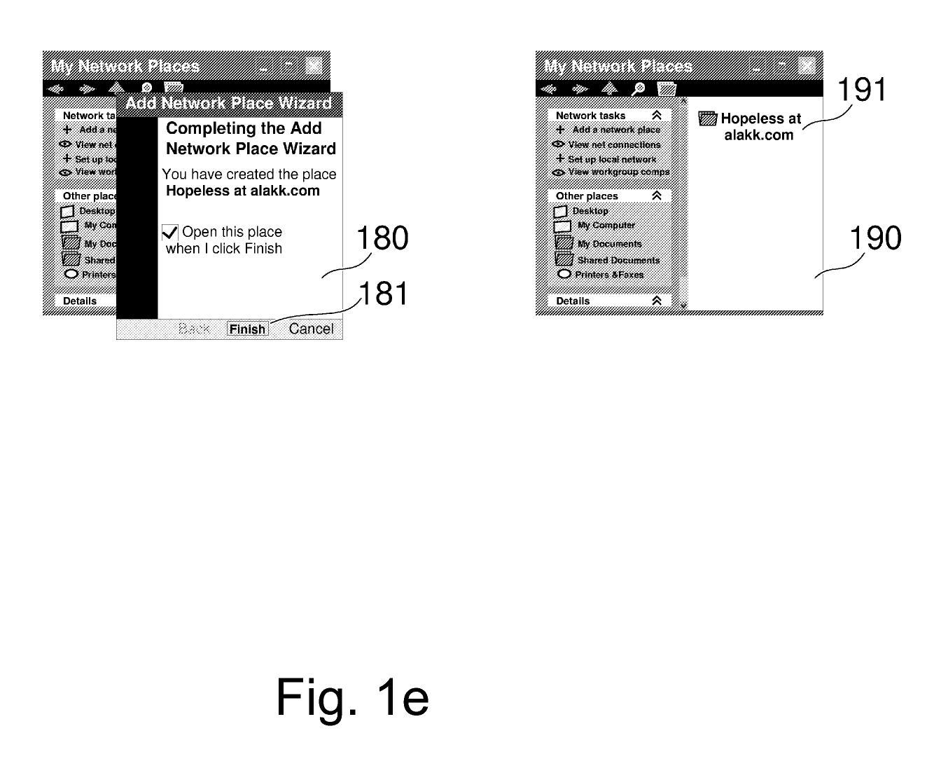

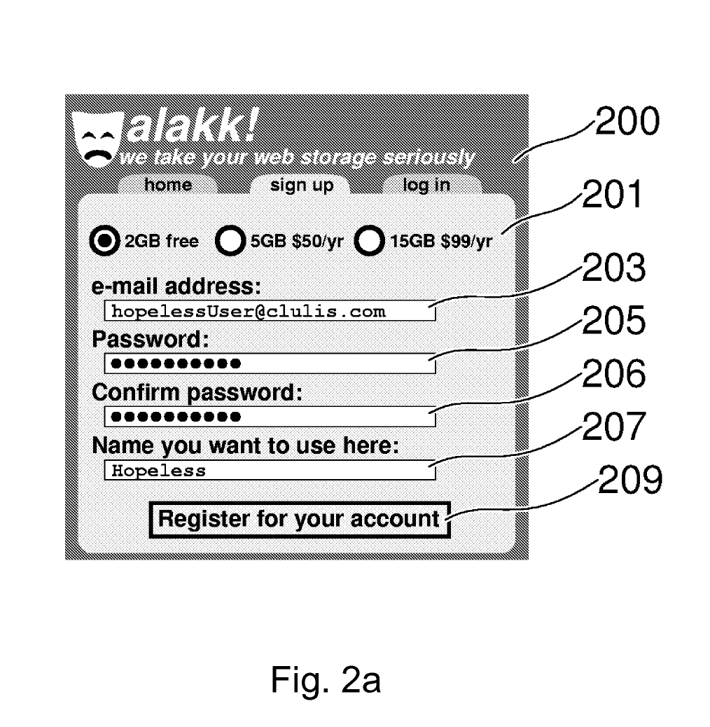

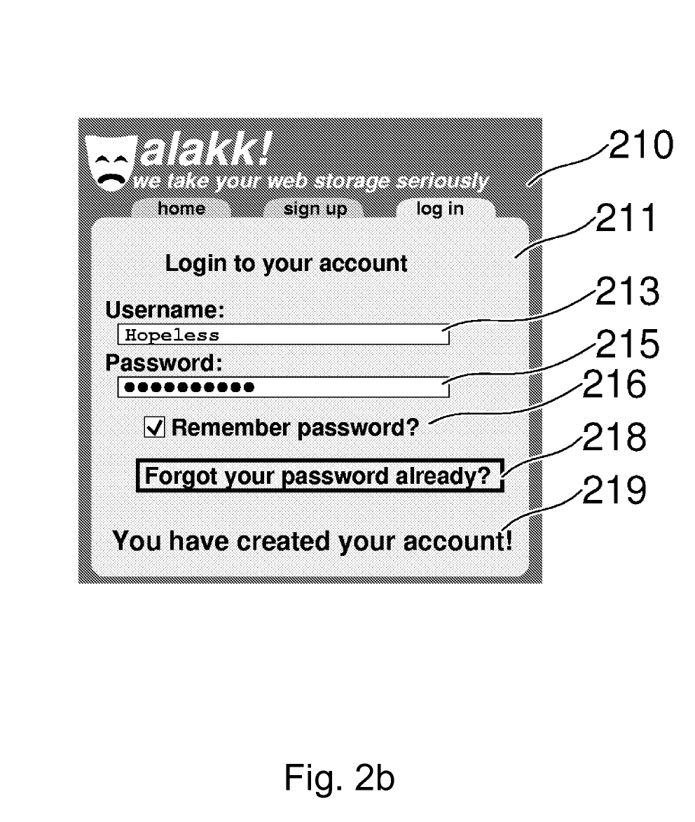

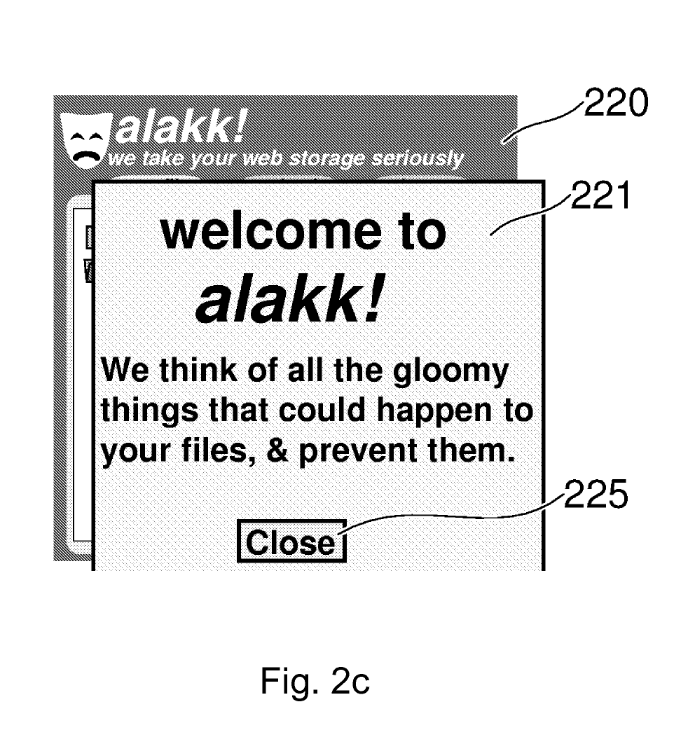

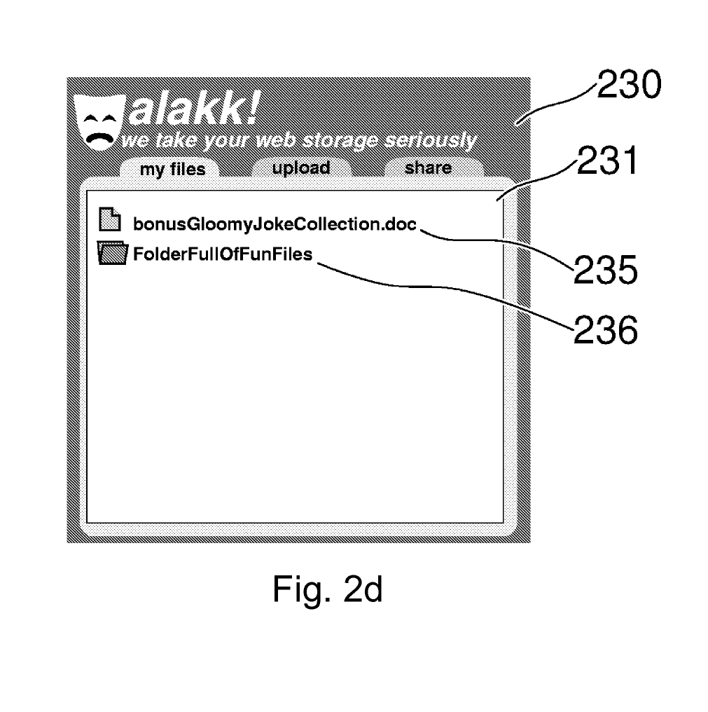

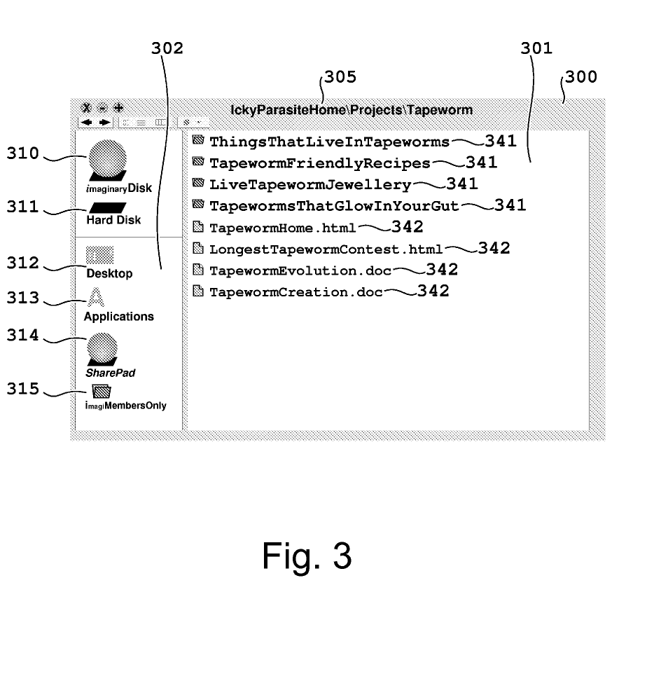

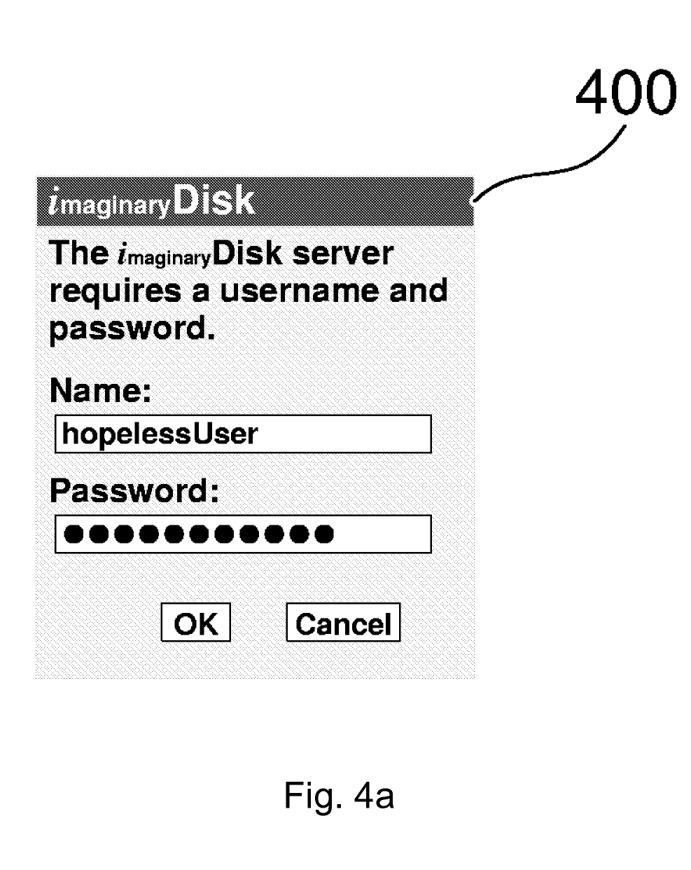

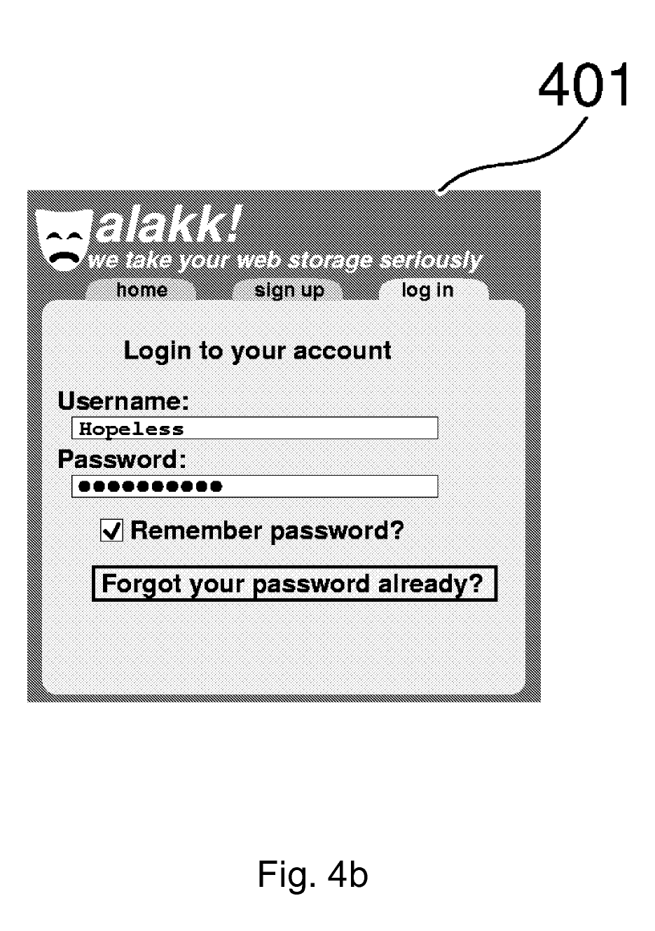

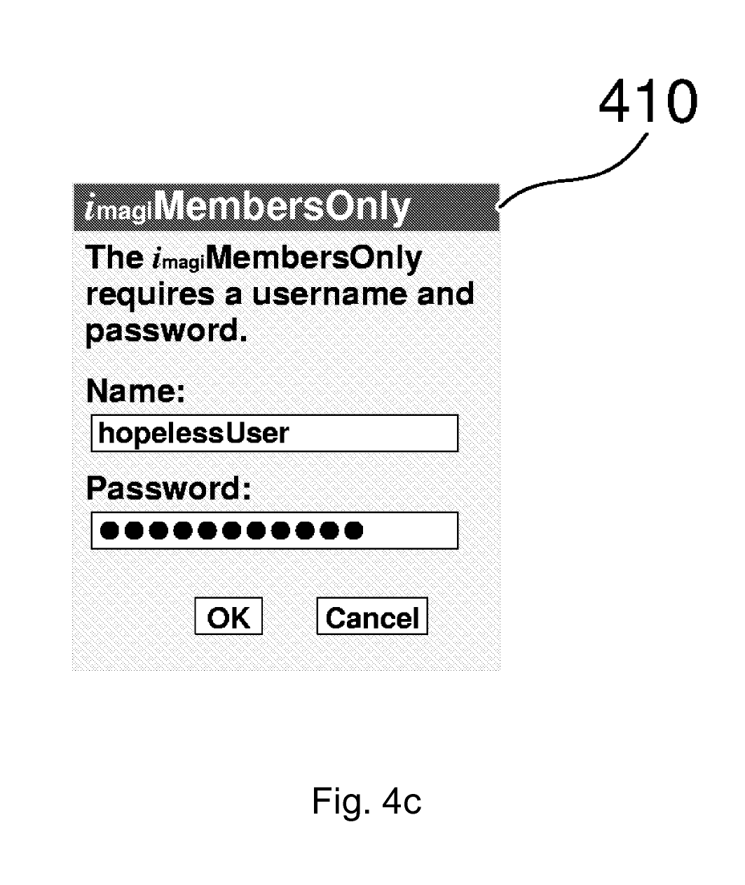

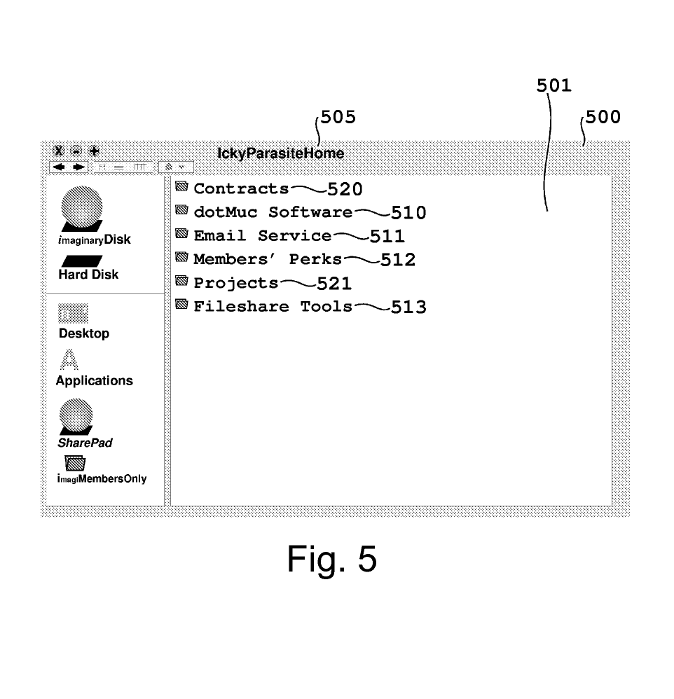

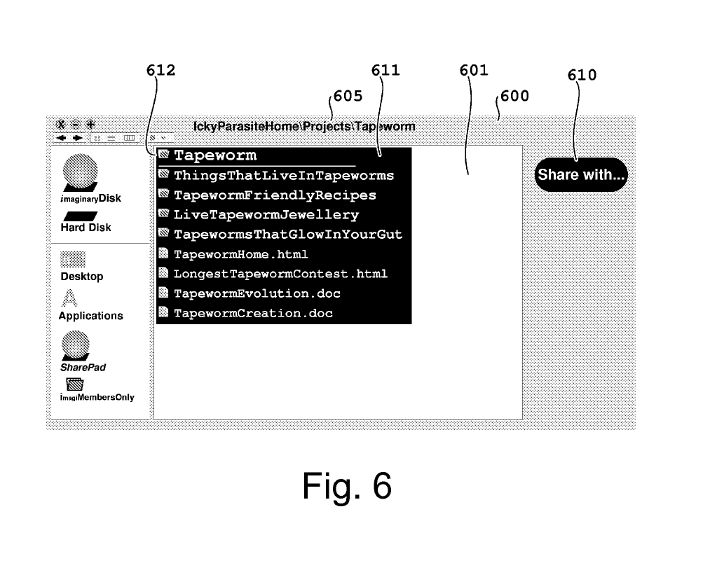

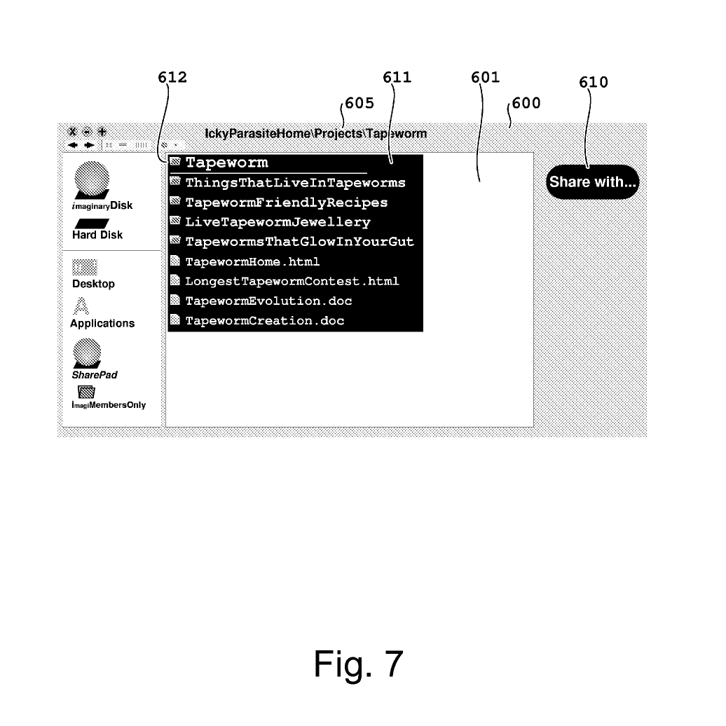

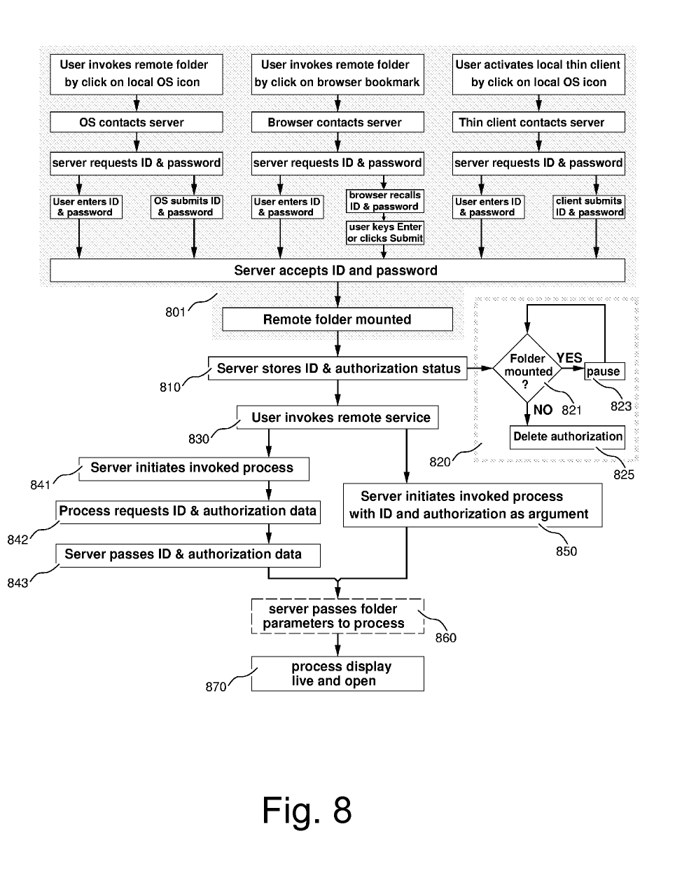

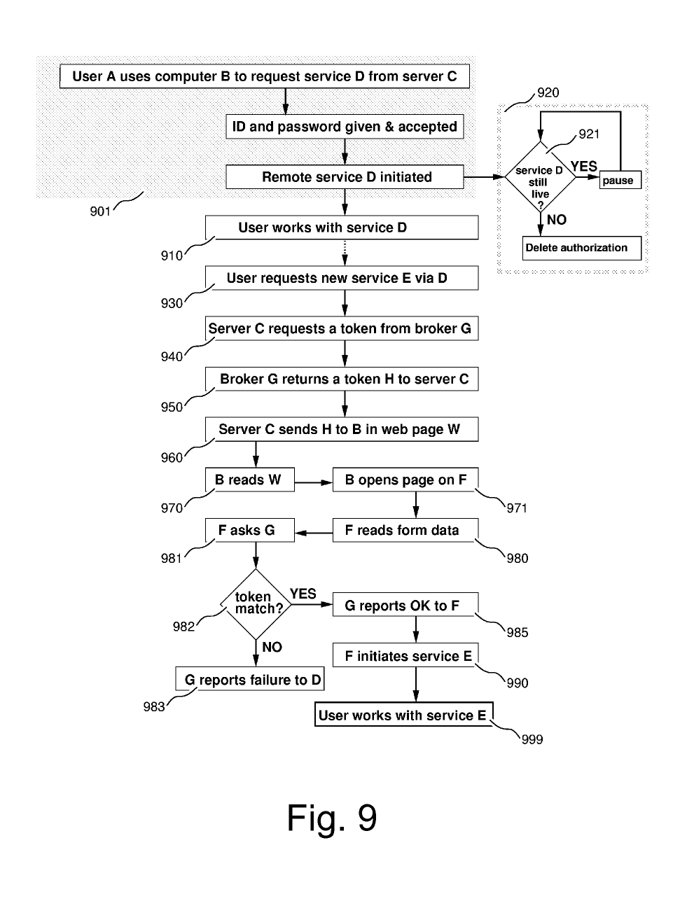

### BACKGROUND OF THE INVENTION

As is widely familiar, an operating system (OS)—among its other functions—provides access to files on a user's computer, or to a permitted subset of files or services on a computer to which the user has access, by what is usually called an ‘account’. (For security reasons, account access is common even for single-user machines). Within this access, means exist to list smaller subsets of files or services, via what are called ‘directories’ in UNIX or Linux, ‘folders’ in Windows or MacOS, which themselves may also occur within the subsets listed in other folders. For historical reasons—a physical piece of paper can be in only one folder at a time—these listable subsets are normally disjoint, though a listable subset may include a link or pointer (labeled as such) to an item in another such subset. A partial escape from this convention is in the MacOS concept of the ‘smart folder’ (for which ‘files in the TapeWorm project’ could overlap with ‘patents filed by IckyParasite.com’, neither contained by the other), though this is more like a facility to group ad-hoc created links than a system of organization. It is not our purpose here to describe an un-treelike navigation schema for displayed sets that may overlap or contain icons for each other, but we shall use ‘folder’ in the broad sense of ‘item set reachable by a selection sequence’, regardless of whether the selections are within a tree-structured system. Selection steps may be steps in a path like diskname:\foldername1\ . . . \foldernamen, or clicks on displayed folder names, or means of broadening or narrowing a database query by typing or by clicking between alternatives, or any other type of selection step whose sequence modifies the list of items displayed. The items themselves will typically be handled by the OS as files, but may equally be commands which invoke congeries of files, paragraphs in a document, table entries in a database, structures pointed to by such entries, or any other type of entity to which discrete displayable identifiers may be assigned or for which they may be generated. In a command-line interface such as UNIX, the user who has reached the desired list would use an entry from it as a command (executing the file) or an argument to a command (opening, moving, copying, filtering, deleting, etc., the file). Even though a command commonly invokes an executable file, there is no necessary one-for-one correspondence between commands and files, since for example a UNIX executable invoked under different names can read the alias used and act differently according to switches in the code, appearing to the user as a different entity. In a graphical user interface (GUI) a mouse user might click to select it, double-click to activate or open it, etc. Two icons displayed in a folder may each represent an alias for one file (which responds differently according to which is clicked), so that icons outnumber files: indeed, an icon may indicate a function offered by the program providing the folder, so that no distinct file corresponds to it. A common GUI convention with a function available with every folder, such as Search or “open the folder containing this one”, to display an icon for it in a border toolbar rather than in a main window, but this is a visual not a logical distinction. Indeed, in UNIX the string “..” represents the containing folder just as “address_list” may represent a particular text file, and is subject to the same syntax. To say that an item or function is ‘in’ a particular folder means that the OS lists it as such (as a textual response to a UNIX “Is” command, as an icon in a GUI window), and usually provides some form of access to it. It may further mean that it is so listed for no other folder, excluding the case of “..”, but we shall use it in the broader sense. What is ‘in’ the folder we call the ‘content’ of the folder.

Almost as familiar is the idea of web access to a service that generates (among other things) displayable lists. At first internet sites displayed mainly fixed pages, but from the start a uniform resource locator (URL) with the universal Hypertext Transfer Protocol “http:” syntax could point to a folder on the host machine, and the user's browser would show the current contents of that folder, although no static HTML file listing those contents existed. (Overriding this, a server often delivers instead from within the folder an “index” file whose name can thus be omitted). Interaction with a listed item, such as downloading it, required the use of additional tools. When web pages became more dynamic, a user could for example enter a search query and see an on-the-fly generated page of results, usually clickable for further action such as browser display or download. (This is distinct from a page with interactive content, so that the user may for example fill in a form or a crossword, where what passes from server to browser is the same for all users).

The fusion of these concepts gives the concept of a web drive, by which material on a remote machine appears (apart from data transfer delays) as much as possible like material on the user's local computer. It is common for a local computer to have more than one physical hard disk or other long-term storage device, and certain OS conventions have become standard for this. Effectively, it appears as a folder in the tree of folders to which the user has access, though with certain variations in behavior. (For example, after dragging a file's icon to a window showing the contents of another folder, the file is ‘in’ that folder: it vanishes from the first folder if and only the folders are on the same disk). At one time a disk with magnetic memory had to be physically mounted in the support rack of a drive that could rotate and read it, so that ‘mount’ has become a synonym for ‘set up arrangements for data exchange with’ a data holder of many types, including a ‘RAM disk’—a region of local short-term memory, to which files are copied for faster access—or a remote file system reached via the world wide web or an intranet. The earlier display metonymy of a disk appearing as a logical folder is now inverted, with a folder appearing as a disk, once ‘mounted’ by an appropriate procedure. This is reflected in inclusion of ‘disk’ in the name for various commercial services that provide remote storage space for a user who can then treat it (almost but not quite) exactly as if it were local data storage. Physically it need not be the whole of a disk on the remote server, nor indeed be confined to a single disk, a single machine or a single geographical area, provided only that the system has a way to find its parts. The terms ‘remote folder’ and ‘remote disk’ may be used interchangeably to refer to the same functionality.

We use the term ‘mount’ to refer not only to the original set-up of such a remote folder, which may set various parameters, allocate space, establish user preferences, confirm a credit card or other payment, etc., but to each instance of contact re-established and authorization confirmed between the user's computer and the server providing the folder's content.

Such remote folders can be mounted via various transfer protocols, such as Samba (SMB), File Transfer Protocol (FTP), and HTTP. The Web-based Distributed Authoring and Versioning (WebDAV) mechanism is a standard (http://www.ietf.org/rfc/rfc2518.txt) issued by the Internet Engineering Task Force in 1998, with a check-in/check-out version management scheme (http://www.ietf.org/rfc/rfc3253.txt) added in 2002. WebDAV functions as an extension of HTTP (alternatively of HTTPS, where the S represents Secure, referring to the supported encryption methods). This relation to the HTTP standards makes it straightforward for an OS creator to add support for either the server or client end of the data transfer involved. This is used by many of the commercial ‘remote disk’ and file-sharing services established from 2000 onward.

To mount such a disk, the user does a sequence of operations specific to the OS and the connection (FTP, WebDAV, Samba, etc.) This procedure is not the direct topic of the present invention for it, but is important context for it. Drawing 1 shows a slightly simplified view of one version of the procedure. The user must click Start to get a window here simplified as 100, and click on (when highlighted) the “My Computer” icon 101. This produces a window 110, in which the user must click a “My Network Places” icon 111, giving a window 120 with that heading. In this the user clicks “Add a network place” 121, and the window 120 is overlaid by the “Wizard” window 130, in which to click “Next” 131. The window 130 becomes the window 140, in which the user must select (not click) the icon 141, then click “Next” 142. The resulting window 150 demands a web address, which the user must obtain (or have ready) and type or copy into the box 151, and again 152 click “Next”. A further overlaid window 160 appears at this point, with boxes 161 and 162 into which the user must type a previously set (and somehow known) name and password respectively, and then 163 click “OK”. The window 160 vanishes, and the window 150 is replaced by the window 170 which requests entering 171 a shortcut for the user's access to the disk. (The instructions can easily confuse the user as to whether a “place” or a “shortcut” is being added. Both terms can be used with a wide range of meanings, and neither is clarified here.) Clicking 172 “Next” is rewarded by the window 180 announcing that the user has created a network place with the name just chosen. (The place, of course, existed before: what has been created is a means of access to it, and a name by which this means can be invoked). After 181 clicking “Finish, the user sees again the window 120 as the window 190, with an added icon 191 which can be double-clicked for a (somewhat) simpler access later to the remote resource. The icon 191 can be dragged from this window to create a duplicate icon wherever it is dropped, such as on the computer's ‘desktop’ or inside a local folder. The MacOS operating system(s) used by Apple computers support a similar procedure, and via Linux there are graphical and command-line based WebDAV clients that are configured to allow access to the remote drive as an extension of the local drive.

Once this has been done once, the user typically has an icon visible on the local machine's desktop or in a chosen folder, which can be ‘opened’ by the clicks usual for opening a folder, causing the system to display the corresponding list. Often this uses an authorization step such as a password, but most operating systems will let the user opt (usually by clicking a button) for the authorization to be stored by the local system and automatically passed to the server each time the user clicks on the icon to open that folder. Often a small log-in window appears, where the user must provide the name 161 and password 162 created as in Drawing 1, or confirm the local memory that has inserted it, but the remote folder (Drawing 4) then opens without further user-visible ado.

From the viewpoint of most users, the process outlined in Drawing 1 (or one of its alternatives) is long, and fraught with anxiety. Every window in this ten-step program has unexplained terms, and (except the redundant window 130) offers opportunity for errors, with no guidance to the user as to how serious the consequences of a mistake may be. (Fail and try again? Just click “Back”? Crash my computer? Open my computer to hackers? Crash the web? How would a non-technical person guess the answers?) Unfortunately, the invention here disclosed does not address the simplification of this process directly. It does, however, reduce the number of times a user must go through it, for access to multiple services (even where these are supplied by different servers).

An alternative means of interacting with remote file storage is the display of a remote folder within a web-browser. This can likewise use various protocols. In this case less of the initial setup is visible (Drawing 2) to the user. After starting the browser and navigating to the web service's “sign up” page 200, the user typically selects a level of service by clicking one of a set 201 of “radio buttons” (or leaving the default chosen), types or pastes in a box 201 an email address for later communication, enters a proposed password in a box 205 for later access, confirms it in a box 206 in case of mistyping, and proposes a user name in a box 207. (The system may reject this name if it is already in use, or fails an automated test for obscenity or religio-political correctness.) Clicking the “Register” button 209 triggers account creation, via the usual communication between web site and browser. This often leads to a view such as 210, with a version 211 of the “log in” page to be used for later connections, where the user must repeat the name (or address) and password just given. This approach does not only save the programmer the effort of coding a separate mechanism for passing these data, different from the later log in which must be coded anyway: it gives an opportunity to expose the data to the browser or OS for later recall if the option 216 is ticked, while the user can still usually recall them. If memory is unusually brief, a button 218 leads to a page which mails the data to the address given in the box 203. A success announcement such as 219 is usually included only in a first-access version of the login page. Login leads to an access page 220, often interrupted by a pop-up welcome 220 which must be closed 225 before the page 220 can be seen. The appearance then typically resembles 231 an OS folder appearing within the page 230. To acculturate the user, the folder may already include a sample file 235 and a sample folder 236, as well as service icons (not shown) whose clicking will trigger the service similarly to the effect of clicking a program icon in the OS. (OS settings as to the effect of single or double clicks, the maximum time gap between the clicks of a double, etc., may or may not be followed—or even detectable—by the software operating the web page).

For simplicity, we refer to this web procedure also as ‘mounting’ the folder, and extend the term also to each later access, which typically involves the steps of opening a ‘log-in’ web page similar to 210 operated by the server, entering the user's name and password (which the user may opt to have stored by the browser and entered automatically), and clicking a submission button or striking the keyboard's Return key.

While initial set-up and configuration may vary in complication and user-deterrence (according to the organization of the server, the OS, and/or the browser), repeat mounting of the remote folder is thus normally straightforward, whether by a “network place” or browser mechanism.

Once the mounting step is complete, the user has access to various functions. Routinely, for example, the user may be able to copy a file or folder (or a set including several files or folders or both) between the remote folder and a local folder, by the ‘drag and drop’ mechanism or other means supported by the local user interface (UI) for transfer of files between folders. This has advantages for back-up, shared access to files, etc. We need not list them here since the improvement of default services is not the subject of the present invention. Other functions normally associated with a mounted remote folder include the ability to create a new remote folder within it, to mount and open the new folder, to transfer files between the new folder and a folder on the user's local computer, and in general to treat a remote folder and its subfolders as though they were part of the file system of the OS, on a separate disk. (more completely so for the mechanism initiated in Drawing 1 than via a web browser) This may or may not include the ability to include remote items in a ‘smart folder’ along with items on the user's local system). These basic services are normally available without further tests of identity or authorization. We refer to the default folder shown when the user has performed the log-in process as the user's ‘home folder’ on the remote system, noting that optionally the system may maintain a record of the user's current folder or subfolder, not deleting it when dismounted or contact is lost, and respond to a new log-in by displaying this current folder rather than the home folder.

The present invention addresses access to services beyond such a default minimum. We illustrate current art with a service we may call i_{maginary}Disk. Initial setup of access follows Drawing 1. This, or a later mounting, leads to Drawing 3. A window 300 includes a folder window 301, showing in this case the particular (fictional) subfolder “Tapeworm” of the subfolder “Projects” of the main remote folder “IckyParasiteHome” used by a company “IckyParasite.com”, as reflected in the subfolder name 305. Many members of the company may open or download the files 342, upload new ones, or open the subfolders 341 and use them similarly. (In contrast to Drawings 1 and 2, this drawing is closer to the style of a Mac interface than to a Windows variant, reflecting the wide context of the invention disclosed below, which should not be construed in as limited to one OS or one of its interfaces). The icon 310 for this service is visible in all OS windows showing files and services, and clicking it when the user's computer is web-connected leads directly to the service, usually (for security reasons) via a login window where the user enters or confirms an identity and a password. (The user's OS or browser may or may not recognize such an entry window, and automatically fill the required boxes. Where the user has accessed the service from a machine normally used by others, this convenience is excluded). It appears in same context, and is used similarly to, the local resource hard disk icon 311, directly under the computer's control without recourse to the web. Similarly the local icons 312 and 313 for the computer's desktop and installed applications share space with an icon 314 for another web service, offering tools for collaboration (for example with clients or content providers) not available in i_{maginary}Disk. The icon 315 represents a folder on the i_{maginary}Disk remote server, describing perquisites available only to paid subscribers. Many variations on this pattern exist.

Note that the user is free to organize (well or badly) the folders and files on the remote server, just as on the local system. Both Windows and Mac OS make a half-hearted attempt to press a system whereby all images are somewhere in one arch-folder, all documents in another, all music in a third, and so on, but neither enforces this. The user who wants to keep all files (of any type) related to a specific project such as “Tapeworm” in Drawing 3 is free to do so, either locally or remotely. The illustrated .html web pages might be better in a web page development folder, separate from the .doc documents, but nothing enforces such a structure other than personal or group practice. This is on balance a good thing, since any design enforced by the system would probably be as painful as the scheme of “My Documents”, “My Music”, etc., but it does mean that the folder structure, constructed on the fly by users, is often ramshackle and slow to navigate. The file one was just working on could be hard to find again, after navigating away from it. The invention disclosed below does not aim to resolve this creative confusion, but does mitigate one of its less pleasant results.

Such services have been available since May 1999 (https://www.freepository.com), and WebDAV has been supported by widely used operating systems since August 2000, making it straightforward to support them. At least fifty such services are offered on line at the time of writing. However, every such service known to us requires a log-in process similar to that in Drawings 1 or 2, as illustrated in Drawing 4, by the window 400 in WebDAV version and by the page 401 for the browser version. This delay is repeated each time the user clicks on an icon for a new remote service, such as in Drawing 3 the SharePad icon 314 or the “Members Only icon” 315—even though the latter is operated by the same server, or a server controlled by the same company, as the i_{maginary}Disk service already open. This delays and inconveniences the user both by the sequence of interaction steps required (and in the case of low bandwidth, by waiting for new displays) and the need for navigation steps if the user wants to work with the specific folder 301 from which the sequence was initiated. In the example of clicking on the “Members Only” icon 315, the new log-in process via the window 410 delivers the user to the default window 500 in Drawing 5, showing a top folder 501, which may or may not be the user's top folder (in this case, folder “IckyParasiteHome”, labelled as 505). If it is not, the user may need to navigate back to that folder after opening the desired service. If it is, it may have a variety of folders automatically provided by i_{maginary}Disk, arranged in folders such as 510, 511, 512 and 513, and often documents (not shown) describing the automatically available services. Mixed among these are an arbitrarily large number of user-created folders, here represented by “Contracts” 520 and “Projects” 521. By the time a user working on the Tapeworm project has found this, clicked it, located the “Tapeworm” folder among the other Projects folders that are then displayed, and clicked on this to return to the Drawing 3 context, her train of thought may be seriously off the rails. A similar result follows if the user must navigate within a framework functioning within an application: even without the web dimension, a user creating PhotoShop™ images in a GallFly project folder who opens Word™ to write a description of them, and seeks to save this as a file in that folder, must navigate the saving mechanism away from a Documents arch-folder far off in the file hierarchy, under either the Windows or Mac OS. The discomfort is magnified by the issues of remote mounting, particularly if web access is slow and each brachiation across the folder tree involves waiting for a response. This, however, is the standard manner in which such services are operated.

It is the purpose of the present invention to avoid this delay and inconvenience to the user, and the repetition with multiple services of the painful initial ‘mounting’ process, thus improving the user's productivity, raising the shareholder value of the user's company, and hastening the return of the great prophet Zarquon.

### BRIEF SUMMARY OF THE INVENTION

When the user mounts a remote folder, the client stores the user's identity and authentication data, as long as the ‘mounted’ state continues. If the user invokes another service requiring identification and/or authentication, stored data are transmitted automatically to the process that provides the service, enabling the current user to be logged in to that process with no visible repetition of the authentication procedure. The embodiment of the invention occurs in two variants, indistinguishable as regards user experience, according to whether the second service is provided by the same or a second server. We describe the single-server variant first.

Furthermore, the present invention permits (but does not require) other initialization data to be passed to the service process. As an example, suppose that the currently mounted folder is a subfolder of the ‘home’ remote folder discussed above. The user may create such a folder in order to share with collaborators the files to be kept in it. In the spirit of the present invention, an icon such as 314 “SharePad” may appear in an “often used” part of the window, mixed (though we do not prefer this) among the icons of every window, or ‘toolbar’ region on the periphery of the window, or otherwise as convenient in a particular embodiment. The effect of the present invention is that ‘opening’ it (typically by ‘double-clicking’ on the icon, but this may vary with user settings), if it relates to a service provide by the same server or one confederated with it, is that the service opens without a new login such as 410, and in our preferred embodiment with an extended version of the window 300 itself, with no navigation required to return focus to that set of files. Drawing 6 illustrates this with a window 600 for a “sharing” service, where an icon 610 leads to a menu by which the user may specify (by username, group name, or email address) other persons who are to be given access to these files and invited to use this access. The details of this invitation process are not of concern here (see the filed “viral recruiting” patent application filed the same date as the present application by the same inventors for an example of such a service): the point of note is that the state of the window 300 is passed to this service, which is able to make intelligent use of it. The same folder name is still 605 visible, and in the window 600 we see marked as “currently selected” 611 the whole set of files and folders visible in the window 300, together with 612 the folder that contains them (that will become the icon through which an invited user will obtain repeated access, assuming that the sharing service is implemented in that manner). Using the usual “Control-Click” or “Command-Click” conventions in current graphical interfaces, the user may remove folders and files such as 720 or 721 from the set to be shared, may reselect items, etc., but this would be under the control of the sharing service. Under the present invention the same selection could be made in the context of the window 301, before invoking the icon “SharePad” 314, and the mechanism of the present invention would transmit the resulting state of the window 301 to allow the sharing application to open with the same selection 711. The rôle of this aspect of the present invention is to identify the folder open at the invocation time of the ‘share’ service to the process that runs that service, automatically, and to transmit its state. An invitation may include encouragement to join the site and to perform the necessary steps to mount a folder. It may also, optionally, just consist of such encouragement, without the inducement of sharing space and files arranged by the inviting user.

If a folder is already shared by a collaborating group, other services will in general be available. For example, the current user may send a message to one or all of the others who have access to the folder on display when the function is invoked, so that the appropriate list is available automatically: the user may invoke such a sending function either from within the sharing application, or by an icon added to the window 300, and can from the window 300 act without a login interruption such as 410, and can present the collaborator list appropriate to the window (or selected set) open when the service is called. In our preferred embodiment either the installation can add such an icon to the window 300, or a user needing it frequently can place it there.

A user with authorization to use an editing service can invoke it for a particular file: the server's data authorizing the user pass automatically to the process providing editing, with no user-visible log-in process or file-specific password entry.

If a shared folder contains many successive versions of a file or files, comparison can automatically construct a ‘descent tree’ showing which versions have already been taken account of in producing later versions. No new authentication step is required if the user invokes the file comparison process on the files in the current folder.

If a user logged in to a web server has a remote account to use an email service, a puzzle, a game, or a plagiarism detection service, the server passes identity and authorization data to the process providing the service, which thus need not subject the user to a separate log-in. The account authorization items may be verified by either the server or the service process, according to programming convenience.

Many similar uses of the present invention will be evident to persons skilled in the art.

Where the service corresponding to an icon is provided by a second server, perhaps remote from the first server connected to as in Drawings 1, 2 or 4, it is necessary to establish a connection between the OS of the user's computer and the second server. The protections normal to such an OS mean that this cannot normally be established by a request to the OS, and the local installation of special software to respond to a connection request is undesirable for many reasons of convenience and security. We disclose a means by which the first server induces an appropriate connection request by the OS to the second server, including an authentication token brokered by a server known to (and trusted by) both the first and second servers, by which the second server is able to validate the connection request. The same mechanism supports transmission of parameters, so that the user experience of an appropriately-opening second service (as well as the absence of a new login) is the same in this case also.

The invention relates to a method under control of a computer system for giving a user access to a plurality of services provided by a computer system, comprising the steps of
obtaining identity data of the user from the user;
validating the user to access a first service of the computer system by analyzing the identity data;
storing validating data indicating that the user is authorized to access the first service;
providing the first service to the user, giving access based on the validating data;
displaying an activation unit arranged to activate an invoke to a second service embedded in a display of the first service;
passing the validating data to the second service upon activation of the activation unit; and
providing the second service to the user, giving access based on the validating data.

In an embodiment the identity data comprises identity information along with authorization data.

In an embodiment the computer system comprises a first computer providing the first service and the second service.

In an embodiment the computer system comprises a first computer providing the first service and a second computer providing the second service.

In an embodiment the first or second services or both are access to folders.

In an embodiment the identity data are retained indirectly by a token, or a hashed representation.

In an embodiment parameters specific to the second service are passed together with the identity data obtained from the user, modifying the second service.

In an embodiment the activation unit represents a file, and the second service enables the user to edit the file.

In an embodiment the second service is to analyze and report on the descent relations among the files in a folder specified by the parameters.

In an embodiment the second service is a service to invite another user to make use of a file or folder.

In an embodiment access to the said folder is automatically granted as a consequence of the said invitation.

In an embodiment the second service is a service to display a list of those with access to the said folder, to send a message to one or more of those with access to the said folder, or to remove another user from the list of those with access to the said folder.

In an embodiment the second service is an email client, a game, or a puzzle.

In an embodiment the first service provides the functions needed by a web community.

In an embodiment the second service is a plagiarism detector, optionally applied by default to all the files in a folder specified by the parameters.

In an embodiment the second service provides a means whereby the connection between itself and the user's computer can be quickly re-established, after the first connection session has ended, when the user re-visits the appropriate page of a web site operated by the second service,

In an embodiment the reconnection occurs automatically and completely by an automatic name and password authentication, or by reference to a cookie on the user's computer.

In an embodiment code on the revisited page obtains and compares a unique identifier for the user's computer with an identifier stored at the time of establishing the means whereby the connection between itself and the user's computer can be re-established, using matching as a condition for completing the re-connection process.

In an embodiment the second service creates an HTML file that the user is invited to save, by the use of the browser's download menu, by drag and drop, or otherwise, such that opening the said file results in re-establishing the connection.

In an embodiment the second service obtains and compares a unique identifier for the user's computer with an identifier stored at the time of establishing the means whereby the connection between itself and the user's computer can be re-established, using matching as a condition for completing the re-connection process.

The invention further discloses a computer program product for giving, to a user already connected to a first server, access to content or a service on a web site provided by a second server, including a computer usable medium having computer program logic stored therein to enable a computer system to perform the steps of
mounting on the first server a first remote service for a user;
in the display of the first remote service, showing the icon of a second service on the second server;
if the user clicks the icon, the first remote server requesting a token from an authentication broker;
the first remote server receiving a token from the authentication broker;
the first server sending the token to the user's system, embedded in a construct to which the normal functioning of the user's system responds by;
sending a message from the user's system to the second server, in which is embedded a request for initiation of service and a copy of the token;
verifying the token in the request for initiation of service by an exchange between the second server and the authentication broker; and
providing the said second service to the user, with no new request to the user for authentication data.

An embodiment of the invention relates to a computer comprising a control unit and a memory wherein a computer program product is stored in the memory arranged to be executed on the control unit, wherein the control unit is arranged to perform the steps of;
obtaining identity data of a user from the user;
validating the user to access a first service of the computer by analyzing the identity data;
storing validating data indicating that the user is authorized to access the first data;
providing the first service to the user, giving access based on the validating data;
displaying an activation unit, embedded in a display presenting the first service, arranged to activate a request to access second service; and
passing the validating data to the second service upon activation of the activation unit for enabling provision of the second service to the user, granting access based on the validating data.

In an embodiment the first service is a service/folder provided locally of the computer device and the second service is a service/folder provided from a different computer.

In an embodiment the first service is a service/folder provided locally of the computer device and the second service is also a service/folder provided locally from the computer.

The invention further relates to a computer program product including a computer usable medium having computer program logic stored therein to enable a computer system to perform the steps of
obtaining identity data of the user from the user;
validating the user to access a first service of the computer system by analyzing the identity data;
storing validating data indicating that the user is authorized to access the first service;
providing the first service to the user, giving access based on the validating data;
displaying an activation unit, embedded in a display presenting the first service, arranged to activate and invoke the second service;
passing the validating data to the second service upon activation of the activation unit; and
providing the second service to the user, giving access based on the validating data.

### BRIEF DESCRIPTION OF THE DRAWINGS

Drawing 1: A typical sequence of displays met in first mounting a remote folder on a local OS.

Drawing 2: A typical sequence of displays met in first mounting a remote folder for browser access.

Drawing 3: A typical WebDAV display of a subfolder within a remote folder.

Drawing 4: Alternative and sometimes repetitious log-in windows, in the style of present art.

Drawing 5: Result in present art when a user logs in to a second service from Drawing 3.

Drawing 6: Result in current invention when a user logs in to a second service from Drawing 3.

Drawing 7: Change in Drawing 6 if the user had made a selection of items in Drawing 3.

Drawing 8: A flow chart of a single-server embodiment of the present invention.

Drawing 9: A flow chart of a multi-server embodiment of the present invention.

### DETAILED DESCRIPTION OF THE INVENTION

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The present invention is described below with reference to block diagrams and/or flowchart illustrations of methods, apparatus (systems) and/or computer program products according to embodiments of the invention. It is understood that several blocks of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

We disclose the invention in two variants: one to support the desired user interaction where the services involved are supplied by a single server, and the other to support it where a second server is involved. The latter presents technical issues not present in the former, but the behavior as perceived by the user is the same. We thus describe the single-server variant first, since it elucidates the desired interaction and its convenience to the user in a simpler context. We then describe the separate-server version, with emphasis on the distinct embodiment details required.

### Single-Server Variant

When the user mounts a remote folder or service—in any of the senses of ‘mount’ specified in the Background to the Invention—the server validates and stores the identity and authentication data of the user, as long as the ‘mounted’ state continues. (The storage may be of the fact that the user is authorized, or of the content of a session cookie token, or of a hashed version of such content or of the data provided by the user, rather than of the surface form of the password or other mechanism by which this state was reached. Many other such variants will be apparent to one skilled in the art, within the spirit of the present invention). If the user clicks on the icon for, or otherwise invokes, a second service that requires identification and/or authentication, the stored data are transmitted automatically to the process that provides the service, enabling the current user to be logged in to that with no visible repetition of the authentication procedure. (If a service requires the additional security of a different password, or permits the user to change to a special identity such as Group Administrator, it may default to the overt method described above. The present invention permits but does not require bypassing the overt procedure). In our preferred embodiment of the single-server version the data are transmitted by the initially-mounted folder or service, or by the server on which both it and the second service are running. Any variant in which the user's computer transmits them would be equally within the spirit of the present invention, but the means by which a remote system causes the user's computer to do so would be apt to be interdicted (as a security risk) in an update of the OS. We therefore prefer to avoid this approach.

Furthermore, the present invention permits (but does not require) other initialization data to be passed to the service process. In particular, as an example, we suppose that the currently mounted folder is a subfolder of the ‘home’ remote folder discussed above. One reason the user may have for creating such a folder is to share with collaborators the files that are to be kept in that folder, without automatically granting them access to every file in or reachable from the user's home folder. For a server supporting this functionality, in the spirit of the present invention, an icon with a name such as ‘SharePad’ is displayed (Drawing 3) either in the item listing window 301 or 314 in a frequent-use region 301 or in a ‘toolbar’ region on the periphery of the window, or in such other manner as is convenient: many such manners will be evident to one skilled in the art of graphical user interface (GUI) design, within the spirit of the present invention. Those skilled in the art of command line interfaces, such as UNIX or its brain-damaged clone DOS, will recognize various means of applying the present invention in that context, since an executable function in such an environment can always discover the directory from which it was invoked, and UNIX practice makes particularly consistent use of this.

Upon the user clicking the sharing icon, a window 600 (Drawing 6) controlled by or interacting with the sharing service appears, containing a clickable item such as but not limited to a button 610, that makes available a process by which the user may identify the chosen collaborators, and displays 611 the set of items to be shared (with their contents, in the case of folders). If the service will make the collaborators' access available under the name of the currently open folder, it may include 612 an identifier for it, but this is an option under the control of the sharing service, enabled by but not a part of the state data transmission that is an aspect of the present invention. A menu (optionally included in the opening display of the window appearing in response to the invocation of the icon 314) may offer the names or other identifiers of the user's previous collaborators in other projects, boxes for entry of e-mail addresses, etc., in ways that will be evident to one skilled in the art. These are not part of the present invention, whose aspect here (beyond the primary communication of user identity and authorization status) is to identify the folder open at the invocation time of the sharing service to the process that runs that service, automatically, and optionally to pass details of its state such as the set of currently selected items; if (Drawing 7) the user had invoked the sharing function while a non-empty selected set excluded the exemplary folder TapewormsThatGlowInYourGut and document TapewormEvolution, the corresponding items 720 and 721 may be excluded from the set displayed 711 as the material to be shared.

It is thus not necessary for the user to specify, after invoking the service, precisely what is to be shared. The default created from the transmitted data will usually suffice, and needs only the user's confirmation, not specification. In case the user wishes to modify the automatically transmitted default, the process may provide means to do so, such as applying Control-Click or Command-Click to move items in the window 701 in or out of the selected set 711, but our preferred embodiment does not require it. An invitation may include encouragement to join the site and to perform the necessary steps to mount a folder: indeed, an invitation to collaborate is the psychologically perfect moment for the invited person to work through the steps in Drawing 1 or Drawing 2. It may also, optionally, consist of such encouragement alone, without the inducement of sharing space and files arranged by the inviting user. As in the filed “viral recruiting” patent application filed the same date as the present application by the same inventors; which is hereby incorporated by reference, the data provided by the existing user in the invitation process may be used to simplify the registration of the invited user.

Where a folder is already shared by a collaborating group of users, one of them may wish to send a message to one or more of the others (separately from whatever other email or other communication channels may be in use among the group), or to all the members of the group. This communication function can optionally be provided, with the process informed of the user identity and authorizations status (hence without a new authentication step) and of the list of users having access to the folder displayed when the function was invoked, so that the appropriate list is available automatically. If the user invokes it from a different folder within that user's same overall remote folder, with a different list of those having access to it, this different list populates the list of those to whom a message of this type may be sent. A related function is simply to display a list of those users with access to the currently displayed remote folder.

The user creating a folder and inviting a group, or a user designated by other means, may be given special powers as Group Administrator, such as but not limited to the power to remove a member of the group from access to the folder and to messages concerning it. By the server's transmission of the stored identity and authorization status to the process handling such functions, together with the identity of the folder from which such a function is invoked, the process may accept the authority of the user to invoke it with reference to that folder, without an additional log-in step.

Similarly, the server may provide a service (perhaps by subscription) for editing files. A user who has previously set up authorization to use this service can invoke it for a particular file (by a command, by double-clicking an icon, or by other means evident to one skilled in the art). The identity and confirmation data stored by the server pass automatically to the process providing the editing service. Unless there is a mismatch with the stored list of those entitled to use the service, no separate user-visible log-in process is required. Any password which may be associated with the file to limit the readability of downloaded copies may be automatically overridden, since the context establishes the user's ability to access the folder, hence the user's authorization to read the folder, hence the user's right to read the file, edit it and save edited copies (not necessarily under the same filename).

A related function can help the user know which file requires editing. If a shared folder contains many successive versions of a file or files, it is possible (see previous descent tree patent application 60/884,230, which is hereby incorporated by reference) to automatically construct a ‘descent tree’ showing which versions have already been directly taken account of in the editing of later versions, by one collaborator or another, and probably do not need to be revisited—though they can be. The user may work with those that have not been further modified by others, and perhaps the user's own most recent version, for comparison. This may be done by using an older editor, or the collaboration-targeting editor described in the descent tree application; for the present invention, the salient point is that no new authentication step is required if the user types a command, or clicks an icon, or otherwise invokes the file comparison process on the files in the current folder. If the user has authority to use the service, the identity and authentication details passed to the process that supplies the service obviate any need for a log-in or password step.

In like manner, if a user who has established on the remote server the right to use an email service, a puzzle (or collection of puzzles), or a single-player game, the stored data can be passed to the process providing the said email, puzzle or game service, which thus does not need to subject the user to a separate log-in. A multi-party game is similar, except that additional services may be involved. These include but are not limited to informing a user currently involved in a game instance as to who else has access rights to a currently on-going game, or who is currently on line and playing, or to enabling a Game Master to expel or discipline a player, without a separate log-in. Other functions like invitation to sharing a game or membership of a discussion group in a web community (issued to people who may or may not already be members of the web service), analogously to sharing a collaboration, can similarly use the present invention to streamline the process from the inviting user's viewpoint.

Another function which may conveniently be offered by a web service is the detection of plagiarism by students. An instructor may individually subscribe to such a service, or be given access by a teaching institution which subscribes. The instructor uploads student submissions into a folder, and ask the system to detect inappropriate matches of passages in the submission with existing sources. (Not all matches are inappropriate: to quote Shakespeare in an essay on Shakespeare is necessary and un-deceitful). It is not our purpose here to handle the mechanisms of such detection: We observe only that once an instructor has obtained authorised access to a web service site, which may provide multiple functions including plagiarism detection, collaboration support as discussed above, or other functions, any function which the instructor has obtained the right to use may be accessed by means of the present invention, without additional log-in procedures. The default set of files to which the function is to be applied is in our preferred embodiment all those files in the currently open remote folder (to which, for example, an instructor may have uploaded all files submitted by students for a particular class assignment), rather than requiring the instructor to select a file or set of files after the process display has opened.

Many similar uses of the present invention will be evident to persons skilled in the art.

The present invention may be embodied as follows: numerous variations of sequence or detail will be evident to those skilled in the art, within the spirit of the invention. Drawing 8 represents the case where a remote folder has already been set up, as in Drawing 1 or Drawing 2, so that mounting it requires only the re-establishment of contact, identity and authorization status. The portion 801 of Drawing 8 represents three among the possible ways to do this, by WebDAV mounting of the remote folder, or via browser, or via a thin client on the user's machine: other means, such as command-line interactions with the user, are also known to those skilled in the art. Each method has more than one alternative for the management of identity and security, shown in the figure as exemplary alternative paths. We do not discuss these means in detail, as they are not a part of the present invention, but merely a necessary context for it.

As a final step 810 of mounting the folder, the server stores user identity (ID) and authorization status in a form that can be recognized by any other remote processes (on or off the initial remote site) that may for the particular system be invoked. In our preferred embodiment the server passes the folder specification, ID and authorization data to a loop 820 which runs concurrently with other activities of the server, checking repeatedly 821 that a mounted folder with these data is still active. If it is, the loop pauses 823 for a standard time interval. Otherwise it deletes 825 the authorization data, which is thus prevented from automatic authorization for another user or a hacker, who might chance on the stored values.

Various interactions such as upload or download of files (depending on user choices) may follow the mounting process 801. Not being the subject of the present invention, these are not discussed here.

When 830 the user invokes a service (such as, but not limited to, the examples of file sharing, descent analysis, collaborative editing, email, game or puzzle playing and plagiarism detection discussed above) which involves identification and authorization beyond that supplied in the mounting process 801, the server may 841 initiate the invoked process, and respond 843 to the process's request 842 for such data by passing the stored values. Alternatively it may initiate the desired process by a call which gives these values as arguments. (In a C++ implementation, the first approach puts a command resembling share( ) in the code of the server object. A function in that code responds to the request generated by the initiated process. In the second approach a call like “share(ID738567, Apq7359)” goes to a function declared in process code as “share(userID, authCodeAddress)” or the like, where userID names a data type used to store unique user identities, and authCodeAddress is the name of a type used to point to hashed versions of authorization codes, which can thus be tested but not copied. Many variants on these approaches, dependent on programming style and security practices, will be apparent to those skilled in the art, within the spirit of the present invention). If the service has a use for the parameter(s) identifying the currently open folder, or otherwise indicating a state to which user interactions have brought the said folder, these may optionally be passed 860 by the server to the process, upon a request (not separately shown) made by the process. Alternatively (not shown), the folder parameter(s) may be passed as additional arguments in step 850, or the exchange in steps 842 and 843 may be enlarged to include the passing of these parameters.

The process now becomes fully active 870, showing a responsive display to the user and performing the services expected of it, without the user having had to perform or even perceive that an identification and authorization interaction was taking place.

### Multi-Server Variant

More broadly, a plurality of servers or service processes, on one or more machines, may collaborate in an authentication sharing pact. A matter to be resolved here is that (unless all the servers run as processes within the server to which the user first logs in, as in Drawing 8, or this server undertakes a permanent go-between or portal function—limiting the freedom of the other servers to innovate in the interactions they support), each such server or process must separately establish a secure connection with the user's machine. It is impractical to request that the second service request contact with the user's computer, which no firewall would allow. Furthermore, the honoring of such requests is not supported by any behavior normally built in to the OS of the user's computer, so that it would require the user to install special software to allow a remote computer to launch a web-based service on the user's own computer. Such installation raises the workload and cognitive load on the user, and poses a security risk that the user should properly resist. It is preferable to use pre-existing OS behaviour to cause the OS itself to initiate such contact with the second service.

Drawing 9 discloses a means to achieve this, as transparently to the user as in the interactions already described above. In an embodiment of the description that follows, two servers referred to by distinct names may be in fact the same server, or be processes running on the same computer (not necessarily physically remote from each other) within the spirit of the invention, which addresses the steps by which information is transferred.

User A on a computer B connects to a remote server C, to use a service D on that server. The user first logs in to C to use D there, authenticating the connection by a standard method such as name and password, or other means known to those skilled in the art. We represent this un-original sequence of events by the grey box 901. Optionally, the server C initiates a persistent loop 920, analogous to the loop 820, that continues to check if the service D is active.

The user A now wants to start a new service, E, hosted on a new server, F.

By a trust relation between servers C and F, we can eliminate the need for the user to perform a new log-in on server F in order to identify herself. Instead we use a token-based authentication method using an ‘authentication broker’ server G. (The server G may in fact be the server C acting in a second capacity, provided it is set up to perform all the functions attributed to G in what follows. Such multiple-rôle options may occur without comment in what follows). The user then works 910 with the service D, as required. The next step shown is an optional pathway, in the sense that it is initiated only if the user wishes to open a second service (not an inevitable step in the first service), which can occur at any point in the user's work with the first service, and is therefore shown dotted.

First the user A uses 930 the service D to invoke the new service, E, hosted on server F. The new service must be invoked via the existing service, as for example by clicking the icon 314 in drawing 3, where i_{maginary}Disk represents service D and the SharePad functionality is provided by service E. Invoking the new service E via the service D on server C causes the server C to request 940 a temporary authentication token from the broker G.

The broker G then returns 950 to the server C an authentication token H, whose validity is time-limited for security reasons. It remains valid for a limited time of n seconds, where n may by way of example be 50, sufficient to complete a launch and authentication procedure: this is achieved by storing it together with a timestamp, on the broker G. It may consist of a randomly chosen large integer, or whatever data type was agreed in setting up the trust relation between the servers. The server C creates a dynamic HTML page W which contains the token H, together with the address, instructions and other information required to start the service E on server F (optionally including parameters derived from the state of the service D, which may be used to control the manner in which E opens, and the resulting display when it does so) and 960 sends this page W to the user's computer B.

The user's computer B reads the page W, and by the default behavior of the OS of B (more specifically, of the file-system viewer in the OS) in accordance with HTML rules and the HTML code in the page W, invokes a browser to display W to the user, which causes the browser 971 to send a page request to the server F, which directs the browser to the desired service E. (The user may or may not see an actual open page corresponding to W, which may or may not contain any HTML code which would generate displayed content beyond a blank page). This request contains a HTML script or form argument in which is embedded the token H.

The server F reads 980 this request, extracts the embedded token and 981 requests confirmation of it from the broker G, which complies 985 only if the token matches the token it sent in step 940. (Evidently the server F may encode the token using a public key published by the broker G, so that only G can decode it and test the match. Many such additional security measures will be evident to those skilled in the art, within the spirit of the present invention). In the event of a failed match, in our preferred embodiment the server G reports the fact to the service D so that the service D can respond with an appropriate error message to the request step 930.

In the case of a successful match, G reports positively 985 to the server F. It also removes the token H from its list of valid tokens, to ensure that any interloper who listened in on the network communication cannot then use for validation the token so obtained. Appropriate secure validation measures set up between F and G, by means well known to those skilled in the art, can ensure that a positive report to F does indeed originate with G.

Only upon receiving the positive report sent 985 does the server F initiate the requested service E, so that the user A can 999 make use of it. If the service E displays a token linking to another service X, with which the server F has a trust relationship similar to that between C and E and involving the same or another authentication broker such as G, the user can at any point initiate a request similar to 930, now requesting X via E, and a similar process to that just described (changing only names, as necessary) permits opening of X, optionally modified by parameter values passed in the request corresponding to W in step 960.

The user's computer B now has an authenticated connection to the service E, which can persist independently of events involving the server C or the service D. The latter are thus not required to continue in a persistent intermediary or portal rôle, and E need not construct its services for delivery through such an intermediary. We have used the operating system on the users computer B to pass a token between servers C and F in order to avoid the need to log in again on server F, given that servers C and F are in a trust relationship. Since the request in step 980 is from the user's computer to server F, and is only submitted to the broker G for authentication, a normal direct relation between the user's computer B and the server F is established by procedures normal to the operating system of B, without the installation on B of software specific to relations with the service E or the server F.

### Repeated Access to the New Service

A further aspect of the present invention is that, having in either the single-server or multi-server version brought the user's computer into productive connection with a second service without subjecting the user even to a log-in process like entering or confirming data in a form like 410, much less to a process of from-scratch mounting like that illustrated in Drawing 1, this connection can be made independently renewable, just as returning to the first server requires no more than the log-in 801 or 901. It is not necessary, if the user later wishes to return to using service E (after the connections established in Drawing 8 or 9 have closed) to repeat the access steps of Drawing 8 or 9, beginning with the log-in 801 or 901. This may be accomplished in a multiplicity of ways, as will be evident to one skilled in the art, and applies equally to the single-server or multi-server versions of the present invention. As exemplary rather than an exhaustive list of such methods, we include the following:

In the simplest such method, the second service (which we again call E) puts a ‘cookie’ on the user's computer so that next time the user visits the website for service E the log-in is renewed automatically, and the service window in the browser opens with the user already logged. However this may be undesirable, for reasons of security (if, for example, others could gain access to the cookie). It is more appropriate to require a log-in, as in Drawing 4, combining reasonable security with avoidance of the mounting processes illustrated in Drawings 1 or 2. JavaScript in the browser may obtain a static unique identifier from the browser or OS, such as the IP address of the user's computer B (where this is static), or a machine identifier, or such other identifiers as may be apparent to one skilled in the art. Inclusion of this identifier, suitably hashed, in the log-in process could support a process of identifying the computer B as the same one where the cookie was originally saved, by comparison with service E's record of the identifier first obtained. In some contexts, where physical access to the computer B is sufficiently controlled, this would provide enough security for the user to opt for automatic log-in.

Alternatively, service E dynamically generates an HTML file that the user is invited to save on the desktop of computer B, or in a convenient folder. Opening this file with the OS of B initiates a sequence of events similar to steps 970 to 999 in Drawing 9, save that for security reasons it is better not to use a time-unlimited token, without which the steps 980 to 985 cannot (and should not) work. These steps may be replaced by a standard log-in, with the service E demanding and receiving a username and password (which as usual may be automatically remembered and inserted by a mechanism on the computer B, if the user's security choices permit this). With the current generation of browsers, the ‘save’ mechanism the user is invited to use cannot from a browser window be a simple drag-and-drop, but most users are familiar with ‘click to download’ and choosing a place to save the resulting file. The use, for the download and placement of such an HTML file, of new developments in built-in browser facilities, of new browser plug-ins becoming widespread, or other means that may allow drag-and-drop from a browser window would be within the spirit of the current invention, as would any other means of presenting a window from which drag-and-drop icon transfer achieves this HTML file placement. Unique identifier authentication methods like those just discussed for the ‘cookie’ approach could avoid the need for the log-in step, with similar impact level on security.

The invention relates to a method for giving access to content or a service on a web site provided by a single server, comprising the steps of obtaining identity and optionally authorization data from a user or the user's computer, mounting on the server a remote service for a user, retaining from the first step the identity and authorization (authentication) data then acquired, showing the icon of a second service, if the user clicks the icon invoking the second service, passing the data to the said second service, and providing the second service to the user, with no new request to the user for authentication data.

In an embodiment the data are retained indirectly by means of a token or hashed representation.

In an embodiment the remote service is provided by a sub-process of a remote service already mounted, and inherits the authentication data.

In an embodiment parameters specific to the service are also passed when passing the data to the iconised and provide second service, thereby modifying the service.

In an embodiment the icon represents a file, and the service enables the user to edit the file.

In an embodiment the service enhanced by parameters specific to that service is to analyze and report on the descent relations among the files in a folder identified by the parameters.

In an embodiment the service is to invite another user to make use of the said site.

In an embodiment the service enhanced by parameters specific to that service is to invite another user to make use of the folder.

Furthermore, where access to the folder is automatically granted as a consequence of the invitation to the other user to make use of the folder.

In an embodiment the service enhanced by parameters specific to that service is to display a list of those with access to the said folder.

In an embodiment the service enhanced by parameters specific to that service is to send a message to one or more of those with access to the said folder.

In an embodiment the service enhanced by parameters specific to that service is to remove another user from the list of those with access to the said folder.

In an embodiment the second service is an email client.

In an embodiment the second service is a game.

In an embodiment the second service is a puzzle.

In an embodiment the second service provides the functions needed by a web community.

In an embodiment the second service is a plagiarism detector.

In an embodiment the second service is a plagiarism detector applied by default to all the files in the said folder.

In an embodiment the second service provides a means whereby the connection between itself and the user's computer can be quickly re-established, after the first connection session has ended.

In an embodiment the re-established connection occurs automatically and completely when the user re-visits the appropriate page of a web site operated by the said second service, which may require a name and password authentication process.

In an embodiment the re-established connection occurs by a name and password authentication when the user re-visits the appropriate page of a web site operated by the said second service.

In an embodiment the data for the re-established connection are drawn from a cookie on the user's computer.

In an embodiment code on the page of the web site operated by the second service obtains and compares a unique identifier for the user's computer with an identifier stored at the time of establishing the means whereby the connection between itself and the user's computer can be re-established, using matching as a condition for completing the re-connection process.

In an embodiment the second service creates an HTML file that the user is invited to save, by a download process from a web page or by ‘drag and drop’ from a displayed remote folder, such that opening the said file results in re-establishing the connection.

In an embodiment the second service obtains and compares a unique identifier for the user's computer with an identifier stored at the time of establishing the means whereby the connection between itself and the user's computer can be re-established, using matching as a condition for completing the re-connection process.

Furthermore, the invention relates to a method for giving, to a user already connected to a first server, access to content or a service on a web site provided by a second server, comprising the steps of mounting on the first server a remote service for a user; in the display of the service, showing the icon of a second service on the second server; if the user clicks the icon, the first server requesting a token from an authentication broker; the first server receiving a token from the authentication broker; the first server sending the token to the user's system, embedded in a construct in response to which the normal functioning of the user's system responds sends a message from the user's system to the second server, in which is embedded a request for initiation of service and a copy of the token; verifying the token in the request to the second server by an exchange between the second server and the authentication broker; providing the second service to the user, with no new request to the user for authentication data.

In an embodiment parameters specific to the said service are also passed in with or in the construct, modifying the second service iconized and provided.

In an embodiment parameters specific to the said second service are also passed in the message from the user's system to the second server, modifying the second service iconized and provided.

In an embodiment the icon represents a file, and the second service enables the user to edit the file.

In an embodiment the second service modified by the parameters is to analyze and report on the descent relations among the files in a folder.

In an embodiment the second service is to invite another user to make use of the site.

In an embodiment the second service is to invite another user to make use of the folder.

In an embodiment access to the folder is automatically granted as a consequence of the invitation.

In an embodiment the second service is to display a list of those with access to the folder.

In an embodiment the second service is to send a message to one or more of those with access to the folder.

In an embodiment the second service is to remove another user from the list of those with access to the said folder.

In an embodiment the second service is an email client.

In an embodiment the second service is a game.

In an embodiment the second service is a puzzle.

In an embodiment the second service provides the functions needed by a web community.

In an embodiment the second service is a plagiarism detector.

In an embodiment the second service is a plagiarism detector and is applied by default to all the files in the said folder.

In an embodiment the second service provides a means whereby the connection between itself and the user's computer can be quickly re-established, after the first connection session has ended.

In an embodiment the re-established connection occurs automatically and completely when the user re-visits the appropriate page of a web site operated by the second service.

In an embodiment the re-established connection occurs by a name and password authentication when the user re-visits the appropriate page of a web site operated by the second service.

In an embodiment the data for the re-established connection are drawn from a cookie on the user's computer.

In an embodiment code on the page obtains and compares a unique identifier for the user's computer with an identifier stored at the time of establishing the means whereby the connection between itself and the user's computer can be re-established, using matching as a condition for completing the re-connection process.

In an embodiment the second service creates an HTML file that the user is invited to save, such that opening the file results in re-establishing the connection.

In an embodiment re-establishing the connection requires a name and password authentication process.

In an embodiment the user saves the said HTML file by download from a web page.

In an embodiment the user saves the said HTML file by ‘drag and drop’ from a displayed remote folder.

In an embodiment the second service obtains and compares a unique identifier for the user's computer with an identifier stored at the time of establishing the means whereby the connection between itself and the user's computer can be re-established, using matching as a condition for completing the re-connection process.

Furthermore, in an embodiment the server is programmed to act according to the description.

Furthermore, in an embodiment a plurality of servers are programmed to act according to the description.

In an embodiment a computer program product performs a method according to the description when executed on a computer.

In the drawings and specification, there have been disclosed exemplary embodiments of the invention. However, many variations and modifications can be made to these embodiments without substantially departing from the principles of the present invention. Accordingly, although specific terms are employed, they are used in a generic and descriptive sense only and not for purposes of limitation, the scope of the invention being defined by the following claims.

What is claimed is:

1. A method under control of a computer system for giving a user access to a plurality of services provided by a computer system, comprising the steps of
obtaining identity data of the user from the user;
validating the user to access a first service of the computer system by analyzing the identity data;
storing validating data indicating that the user is authorized to access the first service;
providing the first service to the user, giving access based on the validating data;
displaying an activation unit arranged to activate an invoke to a second service embedded in a display of the first service;
passing the validating data to the second service upon activation of the activation unit; and
providing the second service to the user, giving access based on the validating data.

2. A method according claim 1, wherein the identity data comprises identity information along with authorization data.

3. A method according to claim 1, wherein the computer system comprises a first computer providing the first service and the second service.

4. A method according to claim 1, wherein the computer system comprises a first computer providing the first service and a second computer providing the second service.

5. A method according to claim 1, wherein the first or second services or both are access to folders.

6. A method according claim 1, wherein the identity data are retained indirectly by a token, or a hashed representation.

7. A method according claim 1, where parameters specific to the second service are passed together with the identity data obtained from the user, modifying the second service.

8. A method according claim 1, where the activation unit represents a file, and the second service enables the user to edit the file.

9. A method according claim 7, where the second service is to analyze and report on the descent relations among the files in a folder specified by the parameters.

10. A method according claim 1, where the second service is a service to invite another user to make use of a file or folder.

11. A method according claim 10, where access to the said folder is automatically granted as a consequence of the said invitation.

12. A method according claim 1, where the second service is a service to display a list of those with access to the said folder, to send a message to one or more of those with access to the said folder, or to remove another user from the list of those with access to the said folder.

13. A method according claim 1, where the second service is an email client, a game, or a puzzle.

14. A method according claim 1, where the first service provides the functions needed by a web community.

15. A method according claim 7, where the second service is a plagiarism detector, optionally applied by default to all the files in a folder specified by the parameters.

16. A method according claim 1, where the second service provides a means whereby the connection between itself and the user's computer can be quickly re-established, after the first connection session has ended, when the user re-visits the appropriate page of a web site operated by the second service,

17. A method according claim 16, where the reconnection occurs automatically and completely by an automatic name and password authentication, or by reference to a cookie on the user's computer.

18. A method according claim 16, where code on the revisited page obtains and compares a unique identifier for the user's computer with an identifier stored at the time of establishing the means whereby the connection between itself and the user's computer can be re-established, using matching as a condition for completing the re-connection process.

19. A method according claim 1, where the second service creates an HTML file that the user is invited to save, by the use of the browser's download menu, by drag and drop, or otherwise, such that opening the said file results in re-establishing the connection.

20. A method according claim 1, where the second service obtains and compares a unique identifier for the user's computer with an identifier stored at the time of establishing the means whereby the connection between itself and the user's computer can be re-established, using matching as a condition for completing the re-connection process.

21. A computer program product for giving, to a user already connected to a first server, access to content or a service on a web site provided by a second server, including a computer usable medium having computer program logic stored therein to enable a computer system to perform the steps of:
mounting on the first server a first remote service for a user;
in the display of the first remote service, showing the icon of a second service on the second server;
if the user clicks the icon, the first remote server requesting a token from an authentication broker;
the first remote server receiving a token from the authentication broker;
the first server sending the token to the user's system, embedded in a construct to which the normal functioning of the user's system responds by;
sending a message from the user's system to the second server, in which is embedded a request for initiation of service and a copy of the token;
verifying the token in the request for initiation of service by an exchange between the second server and the authentication broker;
providing the said second service to the user, with no new request to the user for authentication data.

22. A computer comprising a control unit and a memory wherein a computer program product is stored in the memory arranged to be executed on the control unit, wherein the control unit is arranged to perform the steps of;
obtaining identity data of a user from the user;
validating the user to access a first service of the computer by analyzing the identity data;
storing validating data indicating that the user is authorized to access the first data;
providing the first service to the user, giving access based on the validating data;
displaying an activation unit, embedded in a display presenting the first service, arranged to activate a request to access second service; and
passing the validating data to the second service upon activation of the activation unit for enabling provision of the second service to the user, granting access based on the validating data.

23. A computer according to claim 22, wherein the first service is a service/folder provided locally of the computer device and the second service is a service/folder provided from a different computer.

24. A computer according to claim 22, wherein the first service is a service/folder provided locally of the computer device and the second service is also a service/folder provided locally from the computer.

25. A computer program product including a computer usable medium having computer program logic stored therein to enable a computer system to perform the steps of
obtaining identity data of the user from the user;
validating the user to access a first service of the computer system by analyzing the identity data;
storing validating data indicating that the user is authorized to access the first service;
providing the first service to the user, giving access based on the validating data;
displaying an activation unit, embedded in a display presenting the first service, arranged to activate and invoke the second service;
passing the validating data to the second service upon activation of the activation unit; and
providing the second service to the user, giving access based on the validating data.
